(19) United States
(12) Patent Application Publication
(10) Pub. No.: US 2024/0346603 A1
(43) Pub. Date: Oct. 17, 2024

(54) SYSTEMS, METHODS, AND DEVICES FOR PROCESSING TAX INFORMATION AND PAYMENT

(71) Applicant: TaxPay Inc., Ottawa (CA)

(72) Inventors: Larry Hasson, Ottawa (CA); Andrew Darcy Milne, Ottawa (CA); Charles Jacob Bacal Segal, Ottawa (CA); Julian White, Ottawa (CA)

(21) Appl. No.: 18/630,108

(22) Filed: Apr. 9, 2024

Related U.S. Application Data
(60) Provisional application No. 63/495,882, filed on Apr. 13, 2023.

(51) Int. Cl. G06Q 40/12; G06Q 20/10; H04L 9/40

(52) U.S. Cl. CPC G06Q 40/123; G06Q 20/102; H04L 63/0428

(57) ABSTRACT

A system, method, and device for directly processing tax information and payment is provided. The system comprises at least one processor, a memory, a taxpayer device including a taxpayer profile, a systems server configured to: link the taxpayer profile to a pre-authorized tax payment digital server, extract taxpayer information from the taxpayer profile in the pre-authorized tax payment digital server, generate a tax payment instruction from a taxpayer device associated with the taxpayer profile, generate a taxpayer information package from the tax payment instruction and the taxpayer information, transmit the tax payment instruction to the pre-authorized tax payment digital server, validate the tax payment instruction on the pre-authorized tax payment digital server to verify compliance of the tax payment instruction to a pre-stored automatic tax filing condition, transmit the tax payment instruction on compliance to a tax authority server, and a tax authority server for receiving the tax payment instructions.

### TECHNICAL FIELD

The following relates generally to preparation and filing of tax returns, and more particularly to systems, methods, and devices for directly processing tax information and payment.

### INTRODUCTION

Taxes are levied on income, goods and services, property, and other sources of revenue, and are used to fund government programs and services. The complexity of tax systems varies depending on the country and the jurisdiction and may involve federal and provincial taxes. In many cases, taxes are calculated based on a combination of factors, such as income, deductions, credits, and exemptions, and may be subject to a variety of rules and regulations.

In the case of a corporation, the tax management and payment process includes determination of the corporation's taxable income for the year. This is done by calculating the corporation's revenue and deducting eligible expenses and deductions. Once the taxable income has been determined, the corporation calculates the amount of tax owed using the federal and provincial tax rates. For large corporations, it is common to make tax payments in installments throughout the year. These installments are based on the estimated tax owed for the year and are paid quarterly. At the end of the year, the corporation must file a tax return with the relevant government department, for example the Canada Revenue Agency (CRA), which reports the corporation's taxable income and calculates the final amount of tax owed for the year. If the corporation owes additional tax after filing the tax return, it must pay the outstanding balance by the due date to avoid penalties and interest charges. Alternatively, if the corporation has overpaid taxes, it may be eligible for a refund. Further, if the corporation has incurred losses, it may be able to carry forward those losses to offset future tax liabilities.

Government agencies require corporations to file a variety of tax forms related to their income tax obligations. For illustrative purposes, the Canadian Revenue Agency (CRA) requires the following key forms for the corporate key filings: T2 Corporation Income Tax Return, T2SCH1 Net Income (Loss) for Income Tax Purposes, T2SCH50 Shareholder Information, T2SCH100 Statement of Business or Professional Activities, T2SCH125 Income Statement Information, and T2SCH141 Tax Shield Information. In addition to these forms, corporations may also be required to file additional schedules or forms depending on their specific circumstances, such as if they have foreign affiliates, claim research and development tax credits, or have received dividends from other corporations.

Corporate tax forms can be complex and time-consuming to complete, as they require corporations to provide detailed information about their income, deductions, and credits for the tax year.

Corporations in Canada are subject to both federal and provincial income taxes, which can make tax planning and compliance more complex. Each jurisdiction has its own tax rates and rules, which corporations must take into account when completing their tax forms. Further, corporations must calculate depreciation and amortization for their capital assets, which can add to the complexity. The rules for depreciation and amortization can also change from year to year, requiring corporations to stay up to date on the latest tax regulations.

Corporations may be eligible for a variety of deductions and credits, but determining which ones they qualify for and how to claim them can be difficult to discern. This can include research and development tax credits, capital cost allowance, and foreign tax credits, among others.

Additionally, corporations that engage in cross-border transactions with related parties must comply with transfer pricing rules, which can be complex and require significant documentation. These rules aim to ensure that transactions between related parties are conducted at arm's length, meaning that they are conducted at fair market value.

Taxpayers must ensure that they accurately complete their tax forms and pay the correct amount of tax owed by the deadline, as failure to do so can result in penalties and interest charges. These penalties and interest charges can be significant and can add to the complexity of tax compliance.

Tax information processing includes receiving, storing, and managing tax-related data and information to ensure that taxes are calculated and paid accurately and in compliance with applicable laws and regulations. The processing of tax information involves several steps, including the collection of data, the payee organization details, and interpretation of the data, preparation and the submission of tax forms based on the data, and payments.

Tax information processing has traditionally been a manual and time-consuming process, requiring individuals or businesses to collect and organize a large amount of data and fill out tax forms by hand. However, the development of technology and the availability of tax processing software has made the process more efficient and accurate, enabling individuals and businesses to calculate and file their taxes more easily and quickly.

At present, there has also been a growing trend towards digital tax information processing, with many tax authorities and governments moving towards online tax filing systems and electronic payment options. This trend is expected to continue, as digital tax information processing offers benefits such as increased accuracy, reduced costs, and greater convenience for taxpayers.

To assist taxpayers with preparation and filing of the income tax, tax preparation systems are often used. The purpose of tax preparation systems is to simplify the tax filing process and to reduce the risk of errors or omissions that could result in penalties or fines.

Generally, the tax preparation systems collect necessary information and documents relevant for preparation of a tax return. The information collection may be through either manual entries into the form templates or by importing data from financial institutions or other sources. Once the data has been entered, the systems calculate the tax owed based on the applicable tax rates and rules. The tax preparation systems then generate the necessary tax forms and schedules, and allow the user to file their tax return electronically or by mail.

Overall, the tax preparation systems provide increased accuracy, time savings, and the ability to easily file taxes electronically. Tax preparation systems can also help identify potential deductions or credits that the user may be eligible for, which can help reduce their tax liability.

While tax preparation systems can be a useful tool for many individuals and businesses, there are also several shortcomings and limitations. The systems themselves can be complex and difficult to navigate for some users. Individuals and corporations with complex tax situations may find that the systems do not address all of their unique needs. Further, despite the tax preparation systems being designed to be accurate, errors can still occur if the systems do not account for all relevant tax laws and compliance obligations. These errors can result in penalties or fines from the tax authorities.

Security is an important concern for any system that handles sensitive information, and tax preparation systems are no exception. Tax preparation systems require users to enter sensitive financial information, such as social security numbers (SSN)/Social Insurance Numbers (SINs) and bank account information. This information can be at risk of theft or hacking, which can lead to identity theft or financial fraud. Tax preparation systems can be vulnerable to cyber-attacks, such as malware, phishing scams, and other malicious activities. These attacks can result in the theft of personal and financial information, which can be used for identity theft or fraud. Tax preparation systems can also be vulnerable to data breaches, which can result in the unauthorized access or theft of sensitive data. Data breaches can be caused by vulnerabilities in the system or by human error, such as weak passwords or other security lapses. Further, tax preparation systems may integrate with third-party applications or services, which can introduce additional security vulnerabilities. It is important to ensure that these third-party services also have adequate security measures in place.

Moreover, tax preparation systems are designed to provide a general application of tax laws and regulations and handle basic tax situations, but they may not offer customizations required by a specific business. Further, the tax preparation systems may not be able to handle complex tax situations, such as businesses with multiple shareholders or complex investment portfolios.

Further, tax preparation systems may require manual entry of taxpayer information including account numbers, business numbers, FEIN (Federal Employer Identification Number), and other details. Manual entry of taxpayer details can result in errors or typographical issues, which can lead to incorrect data being entered into the tax preparation system. Moreover, manual entry of taxpayer details can result in inconsistent data being entered into the tax preparation system, particularly for taxpayers who have multiple sources of income or expenses. This can result in errors or omissions on the tax return, which can be difficult to correct. Manual entry of taxpayer details can be time-consuming, particularly for taxpayers with complex tax situations. This can be a particular challenge for tax professionals who may have to enter data for multiple clients.

Taxpayers may be required to submit supporting documentation for their tax returns, such as receipts, invoices, or other records. While tax preparation software may provide instructions for preparing and submitting these documents, they will need to be manually prepared and sent to the appropriate government agency.

Further, complex tax situations require detailed and accurate data input, and tax preparation system may not always provide enough guidance or prompts to ensure that data is entered correctly. This can result in errors or omissions on the tax return.

Initiating tax payment instructions from a tax preparation system may also have some deficiencies. The systems may not always accurately calculate the amount of tax owed or link to the intended taxpayer which can result in errors in the payment. This can result in underpayment or overpayment of taxes, or inclusion of an incorrect taxpayer, which can have consequences for the intended taxpayer. Further, tax preparation systems may not always provide accurate instructions on when tax payments are due. This can result in late payments, which can incur interest or penalties.

A tax preparation system may not always integrate with payment systems, which can result in errors or delays in processing payments. This can be a particular issue for taxpayers who make payments through multiple payment systems or who use different payment methods for different taxes. Further, tax preparation systems may not offer a wide range of payment options, which can be a limitation for taxpayers who prefer to pay by check or other methods. Some taxpayers may also prefer to make partial payments or payment arrangements, which may not be supported by the tax preparation system.

Furthermore, the tax payment system may not be equipped to perform detailed data validation on tax returns, which can result in incorrect processing of a tax return. Additional compliance requirements may need to be met for taxpayers conducting business in multiple jurisdictions, or those engaged in cross-border transactions and complex investments.

The tax preparation systems may provide instructions for preparing the tax returns, and submitting the relevant documents, but they are manually sent to the appropriate government agency. This manual submission of tax documents and payment of tax returns can be a time-consuming process, particularly for taxpayers who have to prepare and file multiple tax returns or who are required to make payments in multiple jurisdictions. Further, manual submission of tax documents and payments can also be prone to errors and omissions, particularly for taxpayers who are not familiar with tax laws and regulations. This can result in penalties or interest charges for underpayment or late payment of taxes. Moreover, for the taxpayers submitting sensitive financial information, there is an added risk that information can be lost, stolen, or compromised during the manual submission process.

Accordingly, systems, methods, and devices are desired that overcome one or more disadvantages associated with existing tax preparation systems and particularly towards direct processing of tax information and payment.

### SUMMARY

A system for directly processing tax information and payment is provided. The system includes at least one processor, a memory connected with the at least one processor, a taxpayer device including a taxpayer profile; a tax authority server for receiving the tax payment instructions, and a systems server. The systems server is configured to link the taxpayer profile to a pre-authorized tax payment digital server; extract taxpayer information from the taxpayer profile in the pre-authorized tax payment digital server, wherein the taxpayer information includes a taxpayer bank account number and taxpayer accounting information; generate a tax payment instruction from a taxpayer device associated with the taxpayer profile; generate a taxpayer information package from the tax payment instruction and the taxpayer information, wherein the taxpayer information package is a computer file that includes the necessary information for processing a tax return; transmit the tax payment instruction to the pre-authorized tax payment digital server; validate the tax payment instruction on the pre-authorized tax payment digital server to verify compliance of the tax payment instruction to a pre-stored automatic tax filing condition; and transmit the tax payment instruction on compliance to a tax authority server.

The systems server may further be configured to unpackage the taxpayer information package to generate the taxpayer information. The taxpayer information package may be placed on a variety of tables in the database. The tables may include information on the user, bank account, tax account, schedule of payments, and completed transactions. The taxpayer information package provides normalizing the data to eliminate redundancy and ensure consistency, and establishing relationships between tables to ensure data integrity and efficient querying. The tables may be queried to piece together the information required to generate the scheduled payment.

The systems server may further be configured to raise an anomaly when the tax payment instruction does not comply with the pre-stored automatic tax filing condition; and automatically transform the tax payment instruction to comply with the pre-stored automatic tax filing condition.

The pre-stored automatic tax filing condition may include a digital file format, a business number format, a reporting number format, a filing date, a reporting period, a tax rate, a data parameter, a net income, and a tax payment certification.

The pre-stored automatic tax filing condition may include either one or more of the file date to be within the reporting period and the tax rate to comply with a net income.

The systems server may further be configured to encrypt the tax payment instruction based on a pre-set encryption protocol.

The system further may comprise a bank server configured to transfer a tax amount to a tax authority account associated with the tax authority server.

The taxpayer accounting information may include a net income, a sales tax number, a taxpayer name, a taxpayer address, and a taxpayer income document so that key details are extracted to process the payment.

A method for directly processing tax information and payment is provided. The method includes linking the taxpayer profile to a pre-authorized tax payment digital server; extracting taxpayer information from the taxpayer profile in the pre-authorized tax payment digital server, wherein the taxpayer information includes a taxpayer bank account number and taxpayer accounting information; generating a tax payment instruction from a taxpayer device associated with the taxpayer profile; generating a taxpayer information package from the tax payment instruction and the taxpayer information, wherein the taxpayer information package is a computer file that includes the necessary information for processing a tax return; transmitting the tax payment instruction to the pre-authorized tax payment digital server; validating the tax payment instruction on the pre-authorized tax payment digital server to verify compliance of the tax payment instruction to a pre-stored automatic tax filing condition; and transmitting the tax payment instruction on compliance to a tax authority server.

The method further may comprise unpackaging the taxpayer information package to generate the taxpayer information.

The method further may comprise raising an anomaly when the tax payment instruction does not comply with the pre-stored automatic tax filing condition; and automatically transforming the tax payment instruction to comply with the pre-stored automatic tax filing condition.

The method may comprise encrypting the tax payment instruction based on a pre-set encryption protocol.

The method may comprise transferring a tax amount to a tax authority account associated with the tax authority server.

A device for directly processing tax information and payment is provided. The device includes a collection module configured to linking the taxpayer profile to a pre-authorized tax payment digital server; a processing module configured to: extracting taxpayer information from the taxpayer profile in the pre-authorized tax payment digital server, wherein the taxpayer information includes a taxpayer bank account number and taxpayer accounting information; validating the tax payment instruction on the pre-authorized tax payment digital server to verify compliance of the tax payment instruction to a pre-stored automatic tax filing condition; a file generation module configured to generating a tax payment instruction from a taxpayer device associated with the taxpayer profile; generating a taxpayer information package from the tax payment instruction and the taxpayer information, wherein the taxpayer information package is a computer file that includes the necessary information for processing a tax return; a file transmission module configured to: transmitting the tax payment instruction to the pre-authorized tax payment digital server; and transmit the tax payment instruction on compliance to a tax authority server.

The processing module may further be configured to unpackage the taxpayer information package to generate the taxpayer information.

The processing module may further be configured to: raising an anomaly when the tax payment instruction does not comply with the pre-stored automatic tax filing condition; and automatically transforming the tax payment instruction to comply with the pre-stored automatic tax filing condition.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 shows a block diagram illustrating the system for directly processing tax information and payment, according to an embodiment.

FIG. 2 shows a simplified block diagram of components of a device, according to an embodiment.

FIG. 3 is a box diagram of a systems device for directly processing tax information and pay, according to an embodiment.

FIG. 4 is a flow diagram of a method for directly processing tax information and payment, according to an embodiment.

FIG. 5A shows a display of the payment schedules in the tax information and payment platform, in accordance with an embodiment.

FIG. 5B shows a display of HST filing in the tax information and payment platform, in accordance with an embodiment.

FIGS. 5C and 5D show a display of an GST/HST Working Form in the tax information and payment platform, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to preparation and filing of tax returns, and more particularly to systems, methods, and devices for directly processing tax information and payment.

Tax information processing and payment includes the collection, processing, and submission of tax-related information and payments to government agencies. In one aspect, the present disclosure provides for a direct and automatic tax information processing and payment solution. The systems provide for management and collection of tax-related information, and direct submission of payments, and documents to the government agency. The system further provides for automated compliance checks to ensure that tax preparation and submission of tax payments and documents are in compliance with tax laws and regulations.

In order to process the tax preparation and submission, the taxpayers must collect and organize their financial and other tax-related information, such as income, expenses, deductions, and credits. According to an embodiment, the present disclosure provides for automated extraction of taxpayer profile and the taxpayer information. The extraction of taxpayer profile and the taxpayer information may be performed on a cloud-based system.

According to an embodiment, the taxpayer profile may be stored in a taxpayer device included in the system for directly processing tax information and payment. The taxpayer device may be linked to a pre-authorized tax payment digital server. The pre-authorized tax payment digital server may be part of a systems server. The pre-authorized tax payment digital server may store the taxpayer information associated with the taxpayer profile. The taxpayer profile may include personal information, including taxpayer name, address, Social Security Number (SSN)/Social Insurance Number (SIN), and other identifying information. The taxpayer information may include taxpayer bank account number, and taxpayer accounting information. The taxpayer account information may include wages, salaries, employee information, investment income, and any other sources of income. This may include forms such as W-2s, 1099s, and other income-related documents. Similar corporate tax processing forms may be included in the taxpayer information. Further, the taxpayer accounting information may include deductions and credits, such as those related to depreciation and business expenses.

The taxpayer accounting information may also include information extracted from financial statements, including balance sheets, income statements, and cash flow statements. The taxpayer accounting information may also include income from multiple sources, including sales revenue, interest income, and other sources of revenue. The taxpayer accounting information may also include expense information including salaries and wages, supplies, rent, and other operating expenses. Further, depreciation and amortization expenses related to capital assets, such as buildings, equipment, and vehicles, and tax credits or deductions that taxpayer may be eligible for, such as research and development credits or investment tax credits may be included in the taxpayer accounting information. Furthermore, for corporations that operate in multiple jurisdictions, taxpayer accounting information may include information on foreign subsidiaries, intercompany transactions, and transfer pricing.

The systems server may further be configured to import data directly from the taxpayer's financial institutions or other sources using the taxpayer profile, reducing the need for manual entry. The systems server may be configured to automatically extract relevant financial and tax-related information from documents and external sources, such as invoices, receipts, bank statements, financial statements, and tax forms. Additionally, the systems server on extraction of relevant taxpayer information may populate the tax forms by automatically filling in the details required to fill the forms using the extracted information.

The systems server may employ data extraction algorithms to identify and extract the relevant tax information from documents and external sources. The systems server may also include tools and features to assist organization and management tax-related documents to calculate their tax liability.

According to an embodiment, the systems server configured to extract taxpayer information from documents and external sources may utilize optical character recognition (OCR), natural language processing (NLP), and data extraction algorithms.

The systems server may utilize OCR technology to extract text from scanned documents, such as invoices, receipts, balance sheets, income statements, and cash flow statements. The systems server scans the document and converts the text into a digital format and stores the relevant information and the nature/category of information that can be processed by the system.

The systems server may utilize NLP technology to analyze the text that has been extracted from the documents. The technology may be used to identify and extract tax-related information, such as the names of vendors, invoice amounts, and tax rates.

The systems server may utilize data extraction algorithms to recognize and extract tax-related information from the documents. The algorithms may be based on processing of tax-related documents and use of statistical analysis to identify patterns and relationships in the data.

The systems server, at the taxpayer information extraction or manual collection stage may also provide for data validation. The systems server may utilize data validation tools to ensure the accuracy and completeness of the extracted information. The tools may include checks for missing data based on the details required for tax preparation, data inconsistencies, and other errors or omissions. The systems server may generate a prompt if automatic processing of extracted or collected taxpayer information is incomplete or inaccurate.

The systems server may also be configured to extract taxpayer information from external sources such as financial institutions using the taxpayer profile.

The systems server may utilize Application Programming Interfaces (APIs): to access customer account information securely from an external source such as financial institutions and governmental organizations. The APIs may be used to extract relevant financial information such as bank transactions, investment portfolio details, and loan details.

To provide data security and privacy, secure connections such as HTTPS or SSL may be used to access the APIs provided by financial institutions or governmental agencies. The secure connections may be provided by the systems server. The external source, for example the financial institution, may provide an authentication token that allows secure access to customer data. An authentication token may include a unique code to identify for the financial institution's API, the systems server or the system for tax preparation processing and payment. The authentication token may be generated by the financial institution when the taxpayer authorizes the systems server to access the taxpayer's financial information.

The authentication token may be generated following a standard industry process such as OAuth. When the taxpayer provides consent through the taxpayer preparation processing and payment platform for a third-party application, an OAuth token may be generated. The OAuth token may be used to access the user's data. This process may be designed to ensure that only authorized third-party applications can access customer data.

Once the authentication token is generated, it may be securely stored by the systems server. The token may be used by the systems server to securely access the customer's financial information through the financial institution's API. The token may be time-limited and may be revoked by the financial institution or the customer at any time to provide an additional layer of security and control.

The extracted financial information may be securely stored in a cloud-based data storage system utilizing data encryption, access controls, backups, and compliance with industry standards and regulations. The data storage system may be designed to provide scalability, high availability, and secure access to the extracted information. The taxpayer information stored on the cloud database may be encrypted both at data storage and data transit, using industry-standard encryption protocols. Further, the encryption protocol may be automatically selected based on the compliance requirements set by governmental agency or the financial institution. Access controls may be implemented to control access to the front end of the tax information processing and payment platform. Access controls may include a combination of password authentication, multi-factor authentication, and user roles and permissions. The cloud-based storage may be further connected to parallel storage systems. The storage systems may be configured to conduct regular backups of the taxpayer information stored on the cloud database to ensure that the data is recoverable in the event of a disaster or data loss. The backups may be encrypted and stored in a separate location to ensure that the data is available when needed.

The cloud database may be configured to automatically comply with industry standards and regulations, such as the General Data Protection Regulation (GDPR) and the Payment Card Industry Data Security Standard (PCI DSS). Selection of compliance standards may be based on the compliance requirements set by governmental agency or the financial institution.

Advantageously, by automatically and securely extracting taxpayer information, the system provides for streamlining the tax preparation process. Taxpayers may not be required to manually enter tax-related data into their tax preparation system, which may save a significant amount of time. To improve accuracy, the taxpayer information data extraction feature is designed to minimize errors and omissions in tax-related data. Further, the extraction of tax information from documents and external sources may be cost-effective, particularly for businesses that need to process large volumes of tax-related data. By automating the tax preparation process and minimizing the risk of errors and omissions, the systems server reduces the risk of non-compliance with tax laws and regulations.

The taxpayer device may be integrated with a tax information and payment application or platform to receive user instructions. The application may provide users with the tools and features to prepare and file their tax returns. The application may include features such as data entry forms, tax calculators, and electronic filing capabilities. The data entry forms may be used to enter tax-related information such as income, deductions, and credits. The application may provide tooltips and guidance for users to fill the forms. The application may also be connected to external sources such as financial institutions, investment platforms, and accounting software. The application may provide tools including calculators to assist users to determine tax liability, estimate refunds, and calculate deductions and credits. The application may provide the user the ability to generate instructions for filing their taxes electronically with the tax authority. The application may automatically populate tax forms and provide guidance with the submission process. The application may be configured to control storage and organization of supporting documents such as receipts, invoices, and other tax-related paperwork.

According to an embodiment, the systems server is configured to receive a tax payment instruction from a taxpayer device associated with the taxpayer profile. The tax payment instruction generation may include receiving the tax payment details from the taxpayer device. The tax payment instructions may include entry of the payment amount, payment period, and payment type into the tax payment software through a user terminal. The payment details can be entered manually or automatically populated by the application based on the taxpayer information extracted by the systems server.

The tax information and payment application may be used to operate the systems server. The tax information and payment application may initiate validation checks on the payment details and tax information received from the taxpayer device to ensure that the payment details are accurate and complete. The validation checks may include checks for missing data, data inconsistencies, and other errors or omissions.

The tax information and payment application may calculate the amount of tax to be paid based on the payment details and tax information entered by the user or the tax information generated by the systems server.

If there is a tax amount remaining to be paid, the tax information and payment application may receive a user instruction from the taxpayer device to select the payment method. The payment methods may include credit card, bank transfer, e-wallet, or other payment options. The tax information and payment application may provide options for different payment methods based on the requirements set by the governmental agency. The tax information and payment application may also include integrations with third-party payment processors.

According to an embodiment, the system may provide for direct and automatic processing of the tax information and payment on receiving an instruction from the taxpayer device. This process may include extraction, by the systems server from the pre-authorized tax payment digital server, of taxpayer information required to process the tax return. The systems server may be configured to generate a taxpayer information package from the tax payment instruction and the taxpayer information. The taxpayer information package is a computer file that includes the necessary information for processing a tax return. The necessary information may include taxpayer accounting information and documents. The necessary information may include taxpayer name, address, Social Security Number (SSN)/Social Insurance Number (SIN), and other identifying information. The necessary information may include taxpayer bank account number, and taxpayer accounting information. The taxpayer accounting information may include wages, salaries, employee information, investment income, and any other sources of income. The taxpayer accounting information may also include documents and forms such as W-2s, 1099s, financial statements, including balance sheets, income statements, cash flow statements; depreciation and amortization expenses related to capital assets, buildings, equipment, and vehicles, and tax credits or deductions; and information on foreign subsidiaries, intercompany transactions, and transfer pricing. The taxpayer accounting information may also include a net income, a sales tax number, a taxpayer name, a taxpayer address, and a taxpayer income document so that key details are extracted to process the payment.

Generation of a taxpayer information package may include combining multiple files relating to the necessary tax information and documents into a single taxpayer information package. The files may relate to different formats. The taxpayer information package may include tax information and documents relevant to a specific jurisdiction. The jurisdiction may be selected through the tax information and payment application. The jurisdiction may be pre-stored on the taxpayer device and may be included in the taxpayer profile. The jurisdiction may also include taxpayer information. The tax information package may include tax forms such as T2 Corporation Income Tax Return, T2SCH1 Net Income (Loss) for Income Tax Purposes, T2SCH50 Shareholder Information, T2SCH100 Statement of Business or Professional Activities, T2SCH125 Income Statement Information, and T2SCH141 Tax Shield Information.

The generation of taxpayer information package may include conversion or compression of files into a specific format. The format may preferably be compatible with the requirements set by the receiving governmental organization.

The files in the taxpayer information package may be organized into a specific data structure. This may include creating a directory structure or folder hierarchy that reflects the organization of the data. The data structure may be selected based on compliance requirements set by the receiving governmental organization.

The taxpayer information package may include metadata to provide additional information about the files, such as the nature of tax document, creation date, and file type. The metadata may be provided based on the compliance requirements set by the receiving governmental organization. Alternatively, the metadata may be generated based on the user preferences set in the taxpayer device.

The taxpayer information package may include tax-related tables, spreadsheets, forms, charts, and other formats depending on the requirements set by the governmental organization or the user.

The taxpayer information package can be encrypted to ensure that it is secure and protected from unauthorized access. A variety of data package encryption tools such as BitLocker™ or VeraCrypt™ may be used to encrypt the taxpayer information package.

The generation of taxpayer information package may include integrating the extracted taxpayer information. This may include combining data from multiple sources, such as financial databases, tax files, APIs of external institutions, and web services. The tax data integration may include data profiling, data cleansing, data transformation, and data loading.

Either one or more data modeling and mapping tools, ETL (Extract, Transform, and Load) tools, data warehousing solutions, and data integration platforms may be used for data packaging and integration to generate the taxpayer information package. Additionally, various standards and protocols, such as SQL (Structured Query Language), XML (Extensible Markup Language), and JSON (JavaScript Object Notation), may be used to provide interoperability and compatibility between different data sources and target systems.

According to an embodiment, once the taxpayer information package is generated and a tax payment instruction is received from the taxpayer device, the systems server is configured to validate the tax payment instruction on the pre-authorized tax payment digital server to verify compliance of the tax payment instruction to a pre-stored automatic tax filing condition. Further, the systems server may be configured to verify compliance of the taxpayer information package.

The verification of the tax payment instruction and the taxpayer information package may be performed against a pre-stored automatic tax filing condition. The pre-stored automatic tax filing condition may be stored in the data storage associated with the systems server. Further, the pre-stored automatic tax filing condition may be stored on the taxpayer device or the data storage associated with pre-authorized tax payment digital server.

The pre-stored automatic tax filing condition may include compliance requirements set by a specific tax jurisdiction. The pre-stored automatic tax filing condition may include one or more of a digital file format, a business number format, a reporting number format, a filing date, a reporting period, a tax rate, a data parameter, a net income, a tax payment certification, or other necessary information and documents. The necessary information may include taxpayer accounting information and documents. Further, the necessary information may include taxpayer name, address, Social Security Number (SSN)/Social Insurance Number (SIN), and other identifying information. Furthermore, the necessary information may include taxpayer bank account number, and taxpayer accounting information. The taxpayer accounting information may include wages, salaries, employee information, investment income, and any other sources of income. The taxpayer accounting information may also include documents and forms such as W-2s, 1099s, financial statements, including balance sheets, income statements, cash flow statements; depreciation and amortization expenses related to capital assets, buildings, equipment, and vehicles, and tax credits or deductions; and information on foreign subsidiaries, intercompany transactions, and transfer pricing. The pre-stored automatic tax filing condition may include compliance requirements set for T2 Corporation Income Tax Return, T2SCH1 Net Income (Loss) for Income Tax Purposes, T2SCH50 Shareholder Information, T2SCH100 Statement of Business or Professional Activities, T2SCH125 Income Statement Information, and T2SCH141 Tax Shield Information.

The systems server is configured to unpackage the taxpayer information package to generate taxpayer information, taxpayer accounting information, and necessary information and document. The unpackaged data is compared and validated against the pre-stored automatic tax filing conditions set for a specific tax jurisdiction.

The pre-stored automatic tax filing conditions may be placed to ensure completeness of the tax return and perform an automated compliance check on the items in the taxpayment instruction and the taxpayer information package. This includes verifying all the required information, including income, expenses, and deductions required by the governmental tax authority. The condition may include verifying that the tax is supported by adequate documentation, including receipts, invoices, and other records that substantiate the income, expenses, and deductions claimed on the return. Further, checks are conducted to validate the forms and schedules for the taxpayer's particular situation.

Additionally, the pre-stored automatic tax filing condition may include verifying the mathematical accuracy of the calculations performed. In the event of an error or discrepancy, an anomaly may be generated.

Further, the pre-stored automatic tax filing condition may include verifying the consistency of the tax return company with the other tax returns filed by the taxpayer, as well as with the taxpayer's financial records.

The pre-stored automatic tax filing condition may also include verifying the timeliness of the submission of tax return, including checks on making necessary payments by the due date. The pre-stored automatic tax filing condition includes either one or more of the file date to be within the reporting period and the tax rate to comply with a net income.

The pre-stored automatic tax filing condition may also include verifying the eligibility for the claimed deductions, credits, and exemptions based on the taxpayer income, filing status, and other relevant factors.

The pre-stored automatic tax filing condition may also include a compliance check with all applicable tax laws and regulations, including federal, state, and local tax laws.

In order to perform the pre-stored automatic tax filing condition checks, the systems server is configured to unpackage the taxpayer information package.

In event the taxpayer information package or the tax payment instruction does not comply with the pre-stored automatic tax filing condition, the systems server may raise an anomaly. The anomaly may include the details on the pre-stored automatic tax filing condition not met.

The systems server may be configured to automatically transform the tax payment instruction and the taxpayer information package to comply with the pre-stored automatic tax filing condition not met earlier. The transformation may be performed based on pre-set rules of tax return correction established for each pre-stored automatic tax filing condition. The rules may include extracting and verifying the taxpayer information to confirm the details related to the anomaly. In the event the transformation is not performed or the anomaly is not rectified, an alert may be raised in the tax information and payment application requiring the manual correction of the anomaly.

According to an embodiment, when the tax payment instruction and the taxpayer information package is validated and found complaint to the pre-stored automatic tax filing condition, the taxpayer information package is transmitted directly to the tax authority server for processing.

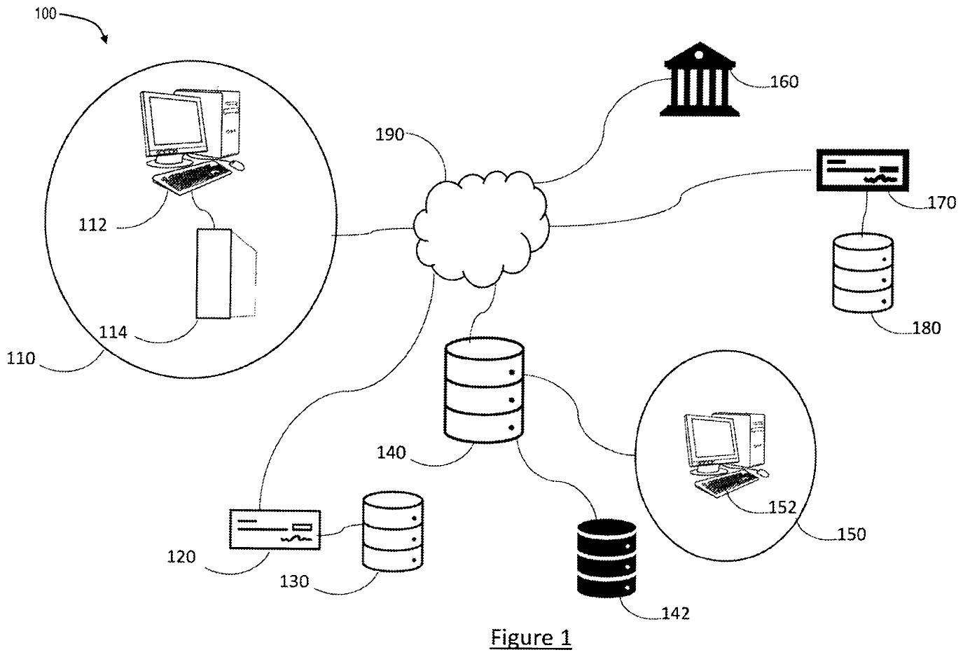

FIG. 1 shows a block diagram illustrating the system for directly processing tax information and payment, in accordance with an embodiment. The system 100 includes a taxpayer device 110, a taxpayer bank device 120, a systems server 140, a governmental tax organization device 160, and a governmental tax organization bank device 170. The taxpayer bank device 120 may be connected to a taxpayer bank server 130. The systems server 140 may be connected to a pre-authorized tax payment digital server 142 and an administrator terminal 150. The governmental tax organization bank device 170 may be connected to a governmental tax organization bank server 180. A communications network 130 may be provided to connect the system.

The taxpayer device 110 may include taxpayer terminal 112 and a taxpayer server 114. The taxpayer device 110 may be operated by a tax payment initiating entity. The administrator terminal 150 may include an administrator device 152 operated by the administrator of the systems server 140.

Each of the devices may be a computer, laptop, tablet, smartphone, or the like, having an input interface (e.g., a keyboard, mouse, or touch screen), a display (e.g., a screen or touchscreen) and network communication components (e.g., a Wi-Fi transceiver). Each device may be associated with a taxpayer organization's account and/or one or more users accounts or administrator accounts. Any suitable mechanism for associating a device with an account/user of the device is expressly contemplated. Although only one taxpayer device 110 is depicted, according to other embodiments, the system 100 may include a plurality of client terminals comprising of a plurality of taxpayer devices, each connected to the systems server 130 over the communications network 130.

The devices may connect to, and exchange data with, the systems server 140 over the wireless communications network 130 (i.e., the internet). In some cases, the network 130 may include other types of computer or telecommunication networks. The devices may be installed with a native application (i.e., a software program) for connecting to and exchanging data with the systems server 130. The native application may refer to a tax information processing and payment application.

The systems server 140 may be one or more servers or web (cloud) servers hosting a platform for direct tax information processing and payment application. For example, the systems server 140 may host a website or application configured for facilitating direct tax information processing and payment as described below. The backend server 140 may be a purpose-built machine designed specifically for receiving and communicating encrypted data in real time from the taxpayer device 110, the taxpayer bank device 120, the systems server 140, the governmental tax organization device 160, and the governmental tax organization bank device 170. The systems server 140 may also be connected to the taxpayer bank server 130, the pre-authorized tax payment digital server 142 and the administrator terminal 150. The systems server 140 may be configured to simultaneously communicate with a plurality of devices and securely transfer data.

The taxpayer device 110, the taxpayer bank device 120, the systems server 140, the governmental tax organization device 160, and the governmental tax organization bank device 170 further include a memory for storing computer-readable instructions, and a processor coupled to the memory for executing the instructions. The memory may include random access memory (RAM) or similar types of memory. Also, the memory may store one or more applications (i.e., computer programs) for execution by the processor. Applications may correspond to software modules comprising computer executable instructions to perform processing for the functions described below. The applications, computer readable instructions or programs may be stored in memory or in secondary storage or may be received from the internet or other network.

Although the taxpayer device 110, the taxpayer bank device 120, the systems server 140, the governmental tax organization device 160, and the governmental tax organization bank device 170 are described with various components, one skilled in the art will appreciate that the devices may in some cases contain fewer, additional, or different components. In addition, although aspects of an implementation of the devices may be described as being stored in memory, one skilled in the art will appreciate that these aspects can also be stored on or read from other types of computer program products or computer-readable media, such as secondary storage devices, including hard disks, solid-state discs, flash memory, floppy disks, CDs, or DVDs; a carrier wave from the Internet or other network; or other forms of RAM or ROM. The computer-readable media may include instructions for controlling the devices to perform a particular method.

In the description that follows, the taxpayer device 110, the taxpayer bank device 120, the systems server 140, the governmental tax organization device 160, and the governmental tax organization bank device 170 are described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

According to an embodiment, the taxpayer profile may be stored in a taxpayer device 110 included in the system 100 for directly processing tax information and payment. The taxpayer device 110 may be linked to a pre-authorized tax payment digital server 142 through the systems server 140. The pre-authorized tax payment digital server 142 may store the taxpayer information associated with the taxpayer profile.

The systems server 140 may further be configured to import data directly from the taxpayer's financial institutions or other sources using the taxpayer profile, reducing the need for manual entry. The institutions include the taxpayer bank 120 and the governmental tax organization 160. The systems server 140 may employ data extraction algorithms to identify and extract the relevant tax information from documents and external sources 120 and 160. The systems server may also include tools and features to assist organization and management tax-related documents to calculate their tax liability.

Advantageously, by automatically and securely extracting taxpayer information, the system 100 provides for streamlining the tax preparation process. Taxpayers may not be required to manually enter tax-related data into their tax preparation system, which may save a significant amount of time. To improve accuracy, the taxpayer information data extraction feature is designed to minimize errors and omissions in tax-related data.

The taxpayer device 110 may be integrated with a tax information and payment application or platform to receive user instructions. The application may provide users with the tools and features to prepare and file their tax returns.

According to an embodiment, the systems server 140 is configured to receive a tax payment instruction from a taxpayer device 110 associated with the taxpayer profile. The tax payment instruction generation may include receiving the tax payment details from the taxpayer device 110.

The tax information and payment application may be used to operate the systems server 140. The tax information and payment application may initiate validation checks on the payment details and tax information received from the taxpayer device 110 to ensure that the payment details are accurate and complete. The validation checks may include checks for missing data, data inconsistencies, and other errors or omissions.

According to an embodiment, the system 100 may provide for direct and automatic processing of the tax information and payment on receiving an instruction from the taxpayer device. This process may include extraction, by the systems server 140, from the pre-authorized tax payment digital server 142, of taxpayer information required to process the tax return.

The generation of taxpayer information package may include integrating the extracted taxpayer information. This may include combining data from multiple sources, such as financial databases, tax files, APIs of external institutions, and web services. The tax data integration may include data profiling, data cleansing, data transformation, and data loading.

According to an embodiment, once the taxpayer information package is generated and a tax payment instruction is received from the taxpayer device 110, the systems server 140 is configured to validate the tax payment instruction on the pre-authorized tax payment digital server 142 to verify compliance of the tax payment instruction to a pre-stored automatic tax filing condition. Further, the systems server 140 may be configured to verify compliance of the taxpayer information package.

The systems server 140 is configured to unpackage the taxpayer information package to generate taxpayer information, taxpayer accounting information, and necessary information and document. The unpackaged data may be compared and validated against the pre-stored automatic tax filing conditions set for a specific tax jurisdiction.

The pre-stored automatic tax filing conditions may be placed to ensure completeness of the tax return and perform an automated compliance check on the items in the taxpayment instruction and the taxpayer information package.

In event the taxpayer information package or the tax payment instruction does not comply with the pre-stored automatic tax filing condition, the systems server may raise an anomaly. The anomaly may include the details on the pre-stored automatic tax filing condition not met.

The systems server 140 may be configured to automatically transform the tax payment instruction and the taxpayer information package to comply with the pre-stored automatic tax filing condition not met earlier. The transformation may be performed based on pre-set rules of tax return correction established for each pre-stored automatic tax filing condition.

According to an embodiment, when the tax payment instruction and the taxpayer information package is validated and found complaint to the pre-stored automatic tax filing condition, the taxpayer information package is transmitted directly to the governmental tax authority 160 and tax authority bank 170 for processing.

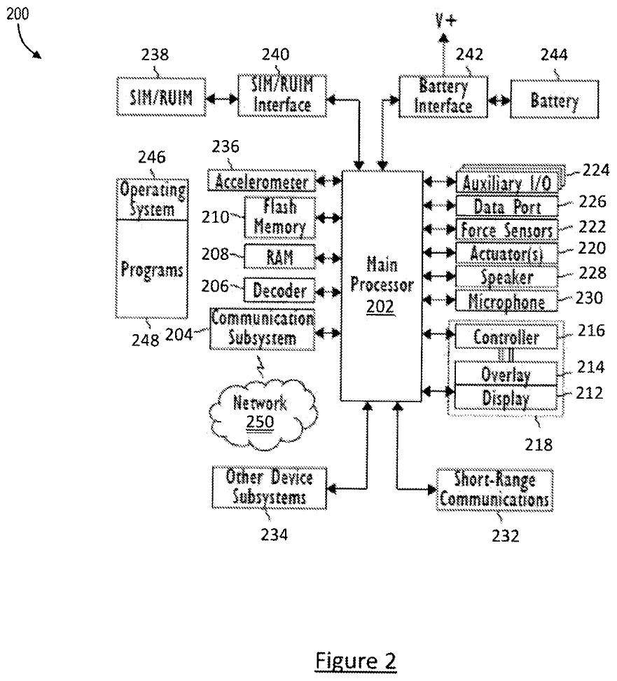

FIG. 2 shows a simplified block diagram of components of a device 200, according to an embodiment. The device 200 may be for example any of the devices shown in FIG. 1. The device 200 includes a processor 202 that controls the operations of the device 200. Communication functions, including data communications, voice communications, or both may be performed through a communication subsystem 204. The communication subsystem 204 may receive messages from, and send messages to, a wireless network 250. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting one or more rechargeable batteries 244.

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

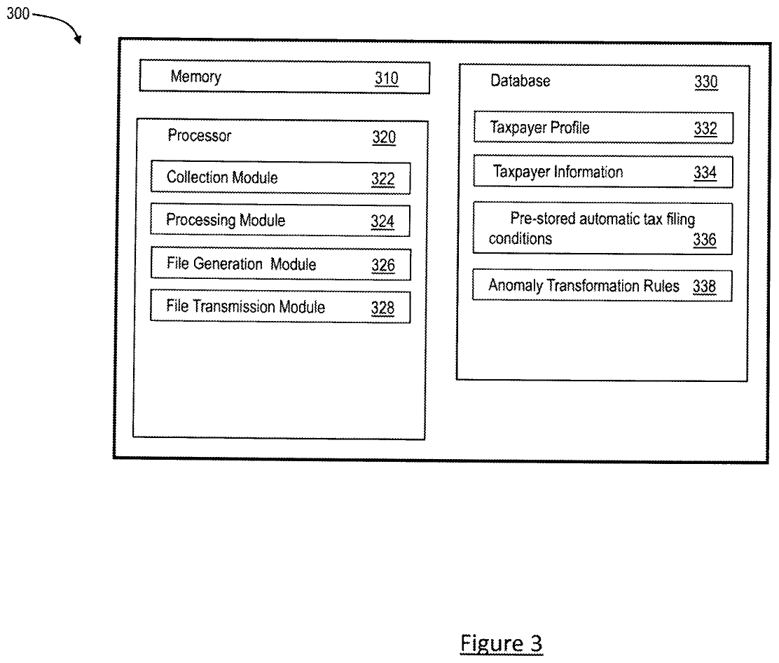

FIG. 3 is a box diagram of a systems device 300 for directly processing tax information and pay, according to an embodiment. The device 300 may be the systems server 140 shown in FIG. 1.

The Device 300 includes a Memory 310, Processor 320, and database 330. According to other embodiments, the Database 330 may be hosted by a separate server connected to the Systems Server 300. According to an embodiment, the database may be located at the pre-authorized tax payment digital server 142 of FIG. 1.

The Processor 320 may include Collection Module 322, Processing Module 324, File Generation Module 326, and File Transmission Module 328.

The database 330 may include a plurality of data tables which may be configured to store data received or processed by the system 100. The database 330 may be configured to store Taxpayer Profile 332, Taxpayer Information 334, Pre-stored Automatic Tax Filing Conditions 336, and Anomaly Transformation Rules 338.

The Collection Module 322 is configured to link the taxpayer profile 332 to a pre-authorized tax payment digital server. According to an embodiment, the taxpayer profile 332 may be stored in the Database 330. According to another embodiment, the taxpayer profile 332 may be stored in a taxpayer device (110) included in the system 100 for directly processing tax information and payment. The taxpayer device (110) may be linked to a pre-authorized tax payment digital server through the systems device 300 or the systems server (140). The pre-authorized tax payment digital server (142) may store the taxpayer information associated with the taxpayer profile. The taxpayer profile may include personal information, including taxpayer name, address, Social Security Number (SSN)/Social Insurance Number (SIN), and other identifying information. The taxpayer information may include taxpayer bank account number, and taxpayer accounting information.

The Processing Module 324 may be configured to extracting taxpayer information 334 from the taxpayer profile 332 in the pre-authorized tax payment digital server, wherein the taxpayer information 334 includes a taxpayer bank account number and taxpayer accounting information.

The Processing Module 324 may be configured to validate the tax payment instruction on the pre-authorized tax payment digital server to verify compliance of the tax payment instruction to a pre-stored automatic tax filing condition.

The taxpayer accounting information may also include information extracted from financial statements, including balance sheets, income statements, and cash flow statements. The taxpayer accounting information may also include income from multiple sources, including sales revenue, interest income, and other sources of revenue.

The systems device 300 may further be configured to import data directly from the taxpayer's financial institutions or other sources using the taxpayer profile, reducing the need for manual entry. The institutions include the taxpayer bank (120) and the governmental tax organization (160). The systems device 300 may be configured to automatically extract relevant financial and tax-related information from documents and external sources, such as invoices, receipts, bank statements, financial statements, and tax forms. Additionally, the systems server (140) on extraction of relevant taxpayer information may populate the tax forms by automatically filling the details required to fill the forms using the extracted information.

The Processing Module 324 may employ data extraction algorithms to identify and extract the relevant tax information from documents and external sources. The Processing Module 324 may also include tools and features to assist organization and management tax-related documents to calculate their tax liability.

According to an embodiment, the Processing Module 324 is configured to extract taxpayer information from documents and external sources may utilize optical algorithms.

The Processing Module 324 may utilize OCR technology to extract text from scanned documents, such as invoices, receipts, balance sheets, income statements, and cash flow statements. The Processing Module 324 scans the document and converts the text into a digital format and stores the relevant information and the nature/category of information that can be processed by the system.

The Processing Module 324 may utilize NLP technology to analyze the text that has been extracted from the documents. The technology may be used to identify and extract tax-related information, such as the names of vendors, invoice amounts, and tax rates.

The Processing Module 324 may utilize data extraction algorithms to recognize and extract tax-related information from the documents. The algorithms may be based on processing of tax-related documents and use of statistical analysis to identify patterns and relationships in the data.

The Processing Module 324, at the taxpayer information extraction or manual collection stage may also provide for data validation. The Processing Module 324 may utilize data validation tools to ensure the accuracy and completeness of the extracted information. The tools may include checks for missing data based on the details required for tax preparation, data inconsistencies, and other errors or omissions. The Processing Module 324 may generate a prompt if automatically processing of extracted or collected taxpayer information is incomplete or inaccurate.

The Processing Module 324 may also be configured to extract taxpayer information from external sources such as financial institutions using the taxpayer profile.

The Processing Module 324 may utilize Application Programming Interfaces (APIs): to access customer account information securely from an external source such as financial institutions 120 and governmental organizations 160. The APIs may be used to extract relevant financial information such as bank transactions, investment portfolio details, and loan details.

To provide data security and privacy, secure connections such as HTTPS or SSL may be used to access the APIs provided by financial institutions 120 or governmental agencies 160. The secure connections may be provided by the systems server. The external source, for example the financial institution 120 may provide an authentication token that allows secure access to customer data.

The authentication token may be generated following a standard industry process such as OAuth. When the taxpayer provides consent through the taxpayer preparation processing and payment platform for a third-party application, an OAuth token may be generated. The OAuth token may be used to access the user's data. This process may be designed to ensure that only authorized third-party applications can access customer data.

The extracted financial information may be securely stored in a cloud-based data storage system 330 utilizing data encryption, access controls, backups, and compliance with industry standards and regulations. The data storage system 330 may be designed to provide scalability, high availability, and secure access to the extracted information. The taxpayer information stored on the cloud database may be encrypted both at data storage and data transit, using industry-standard encryption protocols. Further, the encryption protocol may be automatically selected based on the compliance requirements set by governmental agency or the financial institution.

The cloud database may be configured to automatically comply with industry standards and regulations, such as the General Data Protection Regulation (GDPR) and the Payment Card Industry Data Security Standard (PCI DSS). Selection of compliance standards may be based on the compliance requirements set by governmental agency or the financial institution.

Advantageously, by automatically and securely extracting taxpayer information, the systems device 300 provides for streamlining the tax preparation process. Taxpayers may not be required to manually enter tax-related data into their tax preparation system, which may save a significant amount of time. To improve accuracy, the taxpayer information data extraction feature is designed to minimize errors and omissions in tax-related data. Further, the extraction of tax information from documents and external sources may be cost-effective, particularly for businesses that need to process large volumes of tax-related data. By automating the tax preparation process and minimizing the risk of errors and omissions, the systems device 300 reduces the risk of non-compliance with tax laws and regulations.

The Systems Device 300 may be integrated with a tax information and payment application or platform to receive user instructions. The application may provide users with the tools and features to prepare and file their tax returns. The application may include features such as data entry forms, tax calculators, and electronic filing capabilities.

According to an embodiment, the File Generation Module 326 is configured to generating a tax payment instruction from a taxpayer device (110) associated with the taxpayer profile 332; and generating a taxpayer information package from the tax payment instruction and the taxpayer information, wherein the taxpayer information package is a computer file that includes the necessary information for processing a tax return.

According to an embodiment, the File Transmission Module 328 is configured to transmitting the tax payment instruction to the pre-authorized tax payment digital server (142); and transmitting the tax payment instruction on compliance to a tax authority server.

According to an embodiment, the File Transmission Module 328 is configured to receive a tax payment instruction from a taxpayer device (110) associated with the taxpayer profile 332. The tax payment instruction generation may include receiving the tax payment details from the taxpayer device. The tax payment instructions may include entry of the payment amount, payment period, and payment type into the tax payment software through a user terminal. The payment details can be entered manually or automatically populated by the application based on the taxpayer information extracted by the Collection Module 322.

The tax information and payment application may be used to operate the Systems Device 300. The tax information and payment application may initiate validation checks on the payment details and tax information received from the taxpayer device to ensure that the payment details are accurate and complete. The validation checks may include checks for missing data, data inconsistencies, and other errors or omissions.

The tax information and payment application may calculate the amount of tax to be paid based on the payment details and tax information entered by the user or the tax information generated by the File Generation Module 326.

If there is a tax amount remaining to be paid, the tax information and payment application may receive a user instruction from the taxpayer device to select the payment method. The payment methods may include credit card, bank transfer, e-wallet, or other payment options. The tax information and payment application may provide options for different payment methods based on the requirements set by the governmental agency. The tax information and payment application may also include integrations with third-party payment processors.

According to an embodiment, the Systems Device 300 may provide for direct and automatic processing of the tax information and payment on receiving an instruction from the taxpayer device. This process may include extraction, by the Processing Module 324 from the pre-authorized tax payment digital server, of taxpayer information required to process the tax return. The File Generation Module 326 may be configured to generate a taxpayer information package from the tax payment instruction and the taxpayer information. The taxpayer information package is a computer file that includes the necessary information for processing a tax return.

Generation of a taxpayer information package may include combining multiple files relating to the necessary tax information and documents into a single taxpayer information package. The files may relate to different formats. The taxpayer information package may include tax information and documents relevant to a specific jurisdiction. The jurisdiction may be selected through the tax information and payment application. The jurisdiction may be pre-stored on the taxpayer device and may be included in the taxpayer profile. The jurisdiction may also include taxpayer information.

The generation of taxpayer information package may include conversion or compression of files into a specific format. The format may preferably be compatible with the requirements set by the receiving governmental organization.

The files in the taxpayer information package may be organized into a specific data structure. This may include creating a directory structure or folder hierarchy that reflects the organization of the data. The data structure may be selected based on compliance requirements set by the receiving governmental organization.

The taxpayer information package can be encrypted to ensure that it is secure and protected from unauthorized access. A variety of data package encryption tools such as BitLocker™ or VeraCrypt™ may be used to encrypt the taxpayer information package.

The generation of taxpayer information package may include integrating the extracted taxpayer information. This may include combining data from multiple sources, such as financial databases, tax files, APIs of external institutions, and web services. The tax data integration may include data profiling, data cleansing, data transformation, and data loading.

According to an embodiment, once the taxpayer information package is generated and a tax payment instruction is received from the taxpayer device, the Processing Module 324 is configured to validate the tax payment instruction on the pre-authorized tax payment digital server to verify compliance of the tax payment instruction to a pre-stored automatic tax filing condition. Further, the Systems Device 300 may be configured to verify compliance of the taxpayer information package.

The verification of the tax payment instruction and the taxpayer information package may be performed against a pre-stored automatic tax filing condition 336. The condition 336 may be stored in the data storage 330. Further, the condition 336 may be stored on the taxpayer device or the data storage associated with pre-authorized tax payment digital server.

The condition 336 may include compliance requirements set by a specific tax jurisdiction. The pre-stored automatic tax filing condition may include one or more of a digital file format, a business number format, a reporting number format, a filing date, a reporting period, a tax rate, a data parameter, a net income, a tax payment certification, or other necessary information and documents.

The Processing Module 324 is configured to unpackage the taxpayer information package to generate taxpayer information, taxpayer accounting information, and necessary information and document. The unpackaged data is compared and validated against the pre-stored automatic tax filing conditions set for a specific tax jurisdiction.

The pre-stored automatic tax filing conditions 336 may be placed to ensure completeness of the tax return and perform an automated compliance check on the items in the taxpayment instruction and the taxpayer information package. This includes verifying all the required information, including income, expenses, and deductions required by the governmental tax authority. The condition may include verifying that the tax is supported by adequate documentation, including receipts, invoices, and other records that substantiate the income, expenses, and deductions claimed on the return. Further, checks are conducted to validate the forms and schedules for the taxpayer's particular situation.

Additionally, the condition 336 may include verifying the mathematical accuracy of the calculations performed, verifying the consistency of the tax return company it with the other tax returns filed by the taxpayer, verifying the timeliness of the submission of tax return, verifying the eligibility for the claimed deductions, and a compliance check with all applicable tax laws and regulations, including federal, state, and local tax laws.

In order to perform the pre-stored automatic tax filing condition checks, the systems server is configured to unpackage the taxpayer information package.

The Processing Module 324 is configured to raising an anomaly when the tax payment instruction does not comply with the pre-stored automatic tax filing condition 336; and automatically transforming the tax payment instruction to comply with the pre-stored automatic tax filing condition 336.

In the event the taxpayer information package or the tax payment instruction does not comply with the pre-stored automatic tax filing condition 336, the Processing Module 324 may raise an anomaly. The anomaly may include the details on the pre-stored automatic tax filing condition not met.

The Processing Module 324 may be configured to automatically transform the tax payment instruction and the taxpayer information package to comply with the pre-stored automatic tax filing condition not met earlier. The transformation may be performed based on pre-set rules of tax return correction established for each pre-stored automatic tax filing condition. The rules may include extracting and verifying the taxpayer information to confirm the details related to the anomaly. In the event the transformation is not performed or the anomaly is not rectified, an alert may be raised in the tax information and payment application requiring the manual correction of the anomaly.

According to an embodiment, when the tax payment instruction and the taxpayer information package is validated and found complaint to the pre-stored automatic tax filing condition, the taxpayer information package is transmitted directly to the governmental tax authority and tax authority bank for processing using the File Transmission Module 328.

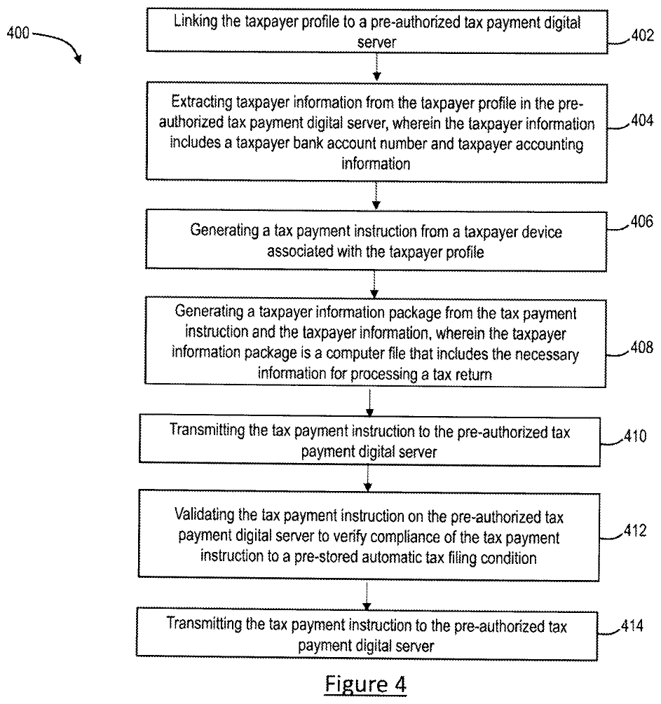

FIG. 4 is a flow diagram of a method 400 for directly processing tax information and payment, according to an embodiment. The method 400 may be performed using the System 100 in FIG. 1. For reference, in the description of method 400, the elements from FIG. 1 are identified in parenthesis.

At 402, linking the taxpayer profile to a pre-authorized tax payment digital server is performed. The taxpayer device (110) may be linked to a pre-authorized tax payment digital server (142) through the systems server (140). The pre-authorized tax payment digital server (142) may store the taxpayer information associated with the taxpayer profile. The taxpayer profile may include personal information, including taxpayer name, address, Social Security Number (SSN)/Social Insurance Number (SIN), and other identifying information. The taxpayer information may include taxpayer bank account number, and taxpayer accounting information. The taxpayer account information may include wages, salaries, employee information, investment income, and any other sources of income. This may include forms such as W-2s, 1099s, and other income-related documents. Similar corporate tax processing forms may be included in the taxpayer information. Further, the taxpayer accounting information may include deductions and credits, such as those related to depreciation and business expenses.

At 404, extracting taxpayer information from the taxpayer profile in the pre-authorized tax payment digital server, wherein the taxpayer information includes a taxpayer bank account number and taxpayer accounting information is performed.

The taxpayer accounting information may also include information extracted from financial statements, including balance sheets, income statements, and cash flow statements. The taxpayer accounting information may also include income from multiple sources, including sales revenue, interest income, and other sources of revenue. The taxpayer accounting information may also include expense information including salaries and wages, supplies, rent, and other operating expenses. Further, depreciation and amortization expenses related to capital assets, such as buildings, equipment, and vehicles, and tax credits or deductions that taxpayer may be eligible for, such as research and development credits or investment tax credits may be included in the taxpayer accounting information. Furthermore, for corporations that operate in multiple jurisdictions, taxpayer accounting information may include information on foreign subsidiaries, intercompany transactions, and transfer pricing.

The systems server (140) may further be configured to import data directly from the taxpayer's financial institutions or other sources using the taxpayer profile, reducing the need for manual entry. The institutions include the taxpayer bank (120) and the governmental tax organization (160). The systems server (140) may be configured to automatically extract relevant financial and tax-related information from documents and external sources, such as invoices, receipts, bank statements, financial statements, and tax forms. Additionally, the systems server (140) on extraction of relevant taxpayer information may populate the tax forms by automatically filling the details required to fill the forms using the extracted information.

The systems server (140) may employ data extraction algorithms to identify and extract the relevant tax information from documents and external sources 120 and 160. The systems server may also include tools and features to assist organization and management tax-related documents to calculate their tax liability.

According to an embodiment, the systems server (140) is configured to extract taxpayer information from documents and external sources may utilize optical algorithms.

The systems server (140) may utilize OCR technology to extract text from scanned documents, such as invoices, receipts, balance sheets, income statements, and cash flow statements. The systems server (140) scans the document and converts the text into a digital format and stores the relevant information and the nature/category of information that can be processed by the system.

The systems server (140) may utilize NLP technology to analyze the text that has been extracted from the documents. The technology may be used to identify and extract tax-related information, such as the names of vendors, invoice amounts, and tax rates.

The systems server (140) may utilize data extraction algorithms to recognize and extract tax-related information from the documents. The algorithms may be based on processing of tax-related documents and use of statistical analysis to identify patterns and relationships in the data.

The systems server (140), at the taxpayer information extraction or manual collection stage may also provide for data validation. The systems server 140 may utilize data validation tools to ensure the accuracy and completeness of the extracted information. The tools may include checks for missing data based on the details required for tax preparation, data inconsistencies, and other errors or omissions. The systems server 140 may generate a prompt if automatically processing of extracted or collected taxpayer information is incomplete or inaccurate.

The systems server (140) may also be configured to extract taxpayer information from external sources such as financial institutions using the taxpayer profile.

The systems server (140) may utilize Application Programming Interfaces (APIs): to access customer account information securely from an external source such as financial institutions (120) and governmental organizations (160). The APIs may be used to extract relevant financial information such as bank transactions, investment portfolio details, and loan details.

To provide data security and privacy, secure connections such as HTTPS or SSL may be used to access the APIs provided by financial institutions (120) or governmental agencies 160. The secure connections may be provided by the systems server. The external source, for example the financial institution (120) may provide an authentication token that allows secure access to customer data. An authentication token may include a unique code to identify for the financial institution's API for the systems server 140 or the system for tax preparation processing and payment. The authentication token may be generated by the financial institution (120) when the taxpayer 110 authorizes the systems server 140 to access the taxpayer's financial information.

The authentication token may be generated following a standard industry process such as OAuth. When the taxpayer provides consent through the taxpayer preparation processing and payment platform for a third-party application, an OAuth token may be generated. The OAuth token may be used to access the user's data. This process may be designed to ensure that only authorized third-party applications can access customer data.

Once the authentication token is generated, it may be securely stored by the systems server (140). The token may be used by the systems server to securely access the customer's financial information through the financial institution's API. The token may be time-limited and may be revoked by the financial institution or the customer at any time to provide an additional layer of security and control.

The extracted financial information may be securely stored in a cloud-based data storage system (142) utilizing data encryption, access controls, backups, and compliance with industry standards and regulations. The data storage system (142) may be designed to provide scalability, high availability, and secure access to the extracted information. The taxpayer information stored on the cloud database may be encrypted both at data storage and data transit, using industry-standard encryption protocols. Further, the encryption protocol may be automatically selected based on the compliance requirements set by governmental agency (160) or the financial institution (120). Access controls may be implemented to control access to the front end of the tax information processing and payment platform. Access controls may include a combination of password authentication, multi-factor authentication, and user roles and permissions. The cloud-based storage may be further connected to parallel storage systems. The storage systems (140) may be configured to conduct regular backups of the taxpayer information stored on the cloud database to ensure that the data is recoverable in the event of a disaster or data loss. The backups may be encrypted and stored in a separate location to ensure that the data is available when needed.

The cloud database may be configured to automatically comply with industry standards and regulations, such as the General Data Protection Regulation (GDPR) and the Payment Card Industry Data Security Standard (PCI DSS). Selection of compliance standards may be based on the compliance requirements set by governmental agency (160) or the financial institution (120).

Advantageously, by automatically and securely extracting taxpayer information, the system (100) provides for streamlining the tax preparation process. Taxpayers may not be required to manually enter tax-related data into their tax preparation system, which may save a significant amount of time. To improve accuracy, the taxpayer information data extraction feature is designed to minimize errors and omissions in tax-related data. Further, the extraction of tax information from documents and external sources may be cost-effective, particularly for businesses that need to process large volumes of tax-related data. By automating the tax preparation process and minimizing the risk of errors and omissions, the systems server 140 reduces the risk of non-compliance with tax laws and regulations.

At 406, generating a tax payment instruction from a taxpayer device associated with the taxpayer profile is performed.

The taxpayer device (110) may be integrated with a tax information and payment application or platform to receive user instructions. The application may provide users with the tools and features to prepare and file their tax returns. The application may include features such as data entry forms, tax calculators, and electronic filing capabilities. The data entry forms may be used to enter tax-related information such as income, deductions, and credits. The application may provide tooltips and guidance for users to fill the forms. The application may also be connected to external sources such as financial institutions, investment platforms, and accounting software. The application may provide tools including calculators to assist users to determine tax liability, estimate refunds, and calculate deductions and credits. The application may provide the user the ability to generate instructions for filing their taxes electronically with the tax authority. The application may automatically populate tax forms and provide guidance with the submission process. The application may be configured to control storage and organization of supporting documents such as receipts, invoices, and other tax-related paperwork.

According to an embodiment, the systems server (140) is configured to receive a tax payment instruction from a taxpayer device (110) associated with the taxpayer profile. The tax payment instruction generation may include receiving the tax payment details from the taxpayer device (110). The tax payment instructions may include entry of the payment amount, payment period, and payment type into the tax payment software through a user terminal. The payment details can be entered manually or automatically populated by the application based on the taxpayer information extracted by the systems server (140).

The tax information and payment application may be used to operate the systems server (140). The tax information and payment application may initiate validation checks on the payment details and tax information received from the taxpayer device (110) to ensure that the payment details are accurate and complete. The validation checks may include checks for missing data, data inconsistencies, and other errors or omissions.

The tax information and payment application may calculate the amount of tax to be paid based on the payment details and tax information entered by the user or the tax information generated by the systems server (140).

If there is a tax amount remaining to be paid, the tax information and payment application may receive a user instruction from the taxpayer device (110) to select the payment method. The payment methods may include credit card, bank transfer, e-wallet, or other payment options. The tax information and payment application may provide options for different payment methods based on the requirements set by the governmental agency 160. The tax information and payment application may also include integrations with third-party payment processors.

According to an embodiment, the system (100) may provide for direct and automatic processing of the tax information and payment on receiving an instruction from the taxpayer device. This process may include extraction, by the systems server (140) from the pre-authorized tax payment digital server (142), of taxpayer information required to process the tax return. The systems server (140) may be configured to generate a taxpayer information package from the tax payment instruction and the taxpayer information. The taxpayer information package is a computer file that includes the necessary information for processing a tax return. The necessary information may include taxpayer accounting information and documents. The necessary information may include taxpayer name, address, Social Security Number (SSN)/Social Insurance Number (SIN), and other identifying information. The necessary information may include taxpayer bank account number, and taxpayer accounting information. The taxpayer accounting information may include wages, salaries, employee information, investment income, and any other sources of income. The taxpayer accounting information may also include documents and forms such as W-2s, 1099s, financial statements, including balance sheets, income statements, cash flow statements; depreciation and amortization expenses related to capital assets, buildings, equipment, and vehicles, and tax credits or deductions; and information on foreign subsidiaries, intercompany transactions, and transfer pricing. The taxpayer accounting information may also include a net income, a sales tax number, a taxpayer name, a taxpayer address, and a taxpayer income document so that key details are extracted to process the payment.

At 408, generating a taxpayer information package from the tax payment instruction and the taxpayer information, wherein the taxpayer information package is a computer file that includes the necessary information for processing a tax return is performed.

Generation of a taxpayer information package may include combining multiple files relating to the necessary tax information and documents into a single taxpayer information package. The files may relate to different formats. The taxpayer information package may include tax information and documents relevant to a specific jurisdiction. The jurisdiction may be selected through the tax information and payment application. The jurisdiction may be pre-stored on the taxpayer device and may be included in the taxpayer profile. The jurisdiction may also include taxpayer information. The tax information package may include tax forms such as T2 Corporation Income Tax Return, T2SCH1 Net Income (Loss) for Income Tax Purposes, T2SCH50 Shareholder Information, T2SCH100 Statement of Business or Professional Activities, T2SCH125 Income Statement Information, and T2SCH141 Tax Shield Information.

The generation of taxpayer information package may include conversion or compression of files into a specific format. The format may preferably be compatible with the requirements set by the receiving governmental organization.

The files in the taxpayer information package may be organized into a specific data structure. This may include creating a directory structure or folder hierarchy that reflects the organization of the data. The data structure may be selected based on compliance requirements set by the receiving governmental organization.

The taxpayer information package may include metadata to provide additional information about the files, such as the nature of tax document, creation date, and file type. The metadata may be provided based on the compliance requirements set by the receiving governmental organization 160. Alternatively, the metadata may be generated based on the user preferences set in the taxpayer device 110.

The taxpayer information package may include tax-related tables, spreadsheets, forms, charts, and other formats depending on the requirements set by the governmental organization or the user.

The taxpayer information package can be encrypted to ensure that it is secure and protected from unauthorized access. A variety of data package encryption tools such as BitLocker™ or VeraCrypt™ may be used to encrypt the taxpayer information package.

The generation of taxpayer information package may include integrating the extracted taxpayer information. This may include combining data from multiple sources, such as financial databases, tax files, APIs of external institutions, and web services. The tax data integration may include data profiling, data cleansing, data transformation, and data loading.

Either one or more of data modeling and mapping tools, ETL (Extract, Transform, and Load) tools, data warehousing solutions, and data integration platforms may be used for data packaging and integration to generate the taxpayer information package. Additionally, various standards and protocols, such as SQL (Structured Query Language), XML (Extensible Markup Language), and JSON (JavaScript Object Notation), may be used to provide interoperability and compatibility between different data sources and target systems.

At 410, transmitting the tax payment instruction to the pre-authorized tax payment digital server is performed.

At 412, validating the tax payment instruction on the pre-authorized tax payment digital server to verify compliance of the tax payment instruction to a pre-stored automatic tax filing condition is performed.

According to an embodiment, once the taxpayer information package is generated and a tax payment instruction is received from the taxpayer device (110), the systems server (140) is configured to validate the tax payment instruction on the pre-authorized tax payment digital server (142) to verify compliance of the tax payment instruction to a pre-stored automatic tax filing condition. Further, the systems server (140) may be configured to verify compliance of the taxpayer information package.

The verification of the tax payment instruction and the taxpayer information package may be performed against a pre-stored automatic tax filing condition. The pre-stored automatic tax filing condition may be stored in the data storage associated with the systems server (140). Further, the pre-stored automatic tax filing condition may be stored on the taxpayer device (110) or the data storage associated with pre-authorized tax payment digital server (142).

The pre-stored automatic tax filing condition may include compliance requirements set by a specific tax jurisdiction. The pre-stored automatic tax filing condition may include one or more of a digital file format, a business number format, a reporting number format, a filing date, a reporting period, a tax rate, a data parameter, a net income, a tax payment certification, or other necessary information and documents. The necessary information may include taxpayer accounting information and documents. Further, the necessary information may include taxpayer name, address, Social Security Number (SSN)/Social Insurance Number (SIN), and other identifying information. Furthermore, the necessary information may include taxpayer bank account number, and taxpayer accounting information. The taxpayer accounting information may include wages, salaries, employee information, investment income, and any other sources of income. The taxpayer accounting information may also include documents and forms such as W-2s, 1099s, financial statements, including balance sheets, income statements, cash flow statements; depreciation and amortization expenses related to capital assets, buildings, equipment, and vehicles, and tax credits or deductions; and information on foreign subsidiaries, intercompany transactions, and transfer pricing. The pre-stored automatic tax filing condition may include compliance requirements set for T2 Corporation Income Tax Return, T2SCH1 Net Income (Loss) for Income Tax Purposes, T2SCH50 Shareholder Information, T2SCH100 Statement of Business or Professional Activities, T2SCH125 Income Statement Information, and T2SCH141 Tax Shield Information.

The systems server (140) is configured to unpackage the taxpayer information package to generate taxpayer information, taxpayer accounting information, and necessary information and document. The unpackaged data is compared and validated against the pre-stored automatic tax filing conditions set for a specific tax jurisdiction.

The pre-stored automatic tax filing conditions may be placed to ensure completeness of the tax return and perform an automated compliance check on the items in the taxpayment instruction and the taxpayer information package. This includes verifying all the required information, including income, expenses, and deductions required by the governmental tax authority. The condition may include verifying that the tax is supported by adequate documentation, including receipts, invoices, and other records that substantiate the income, expenses, and deductions claimed on the return. Further, checks are conducted to validate the forms and schedules for the taxpayer's particular situation.

Additionally, the pre-stored automatic tax filing condition may include verifying the mathematical accuracy of the calculations performed. In the event of an error or discrepancy, an anomaly may be generated.

Further, the pre-stored automatic tax filing condition may include verifying the consistency of the tax return company with the other tax returns filed by the taxpayer, as well as with the taxpayer's financial records.

The pre-stored automatic tax filing condition may also include verifying the timeliness of the submission of tax return, including checks on making necessary payments by the due date. The pre-stored automatic tax filing condition includes either one or more of the file date to be within the reporting period and the tax rate to comply with a net income.

The pre-stored automatic tax filing condition may also include verifying the eligibility for the claimed deductions, credits, and exemptions based on the taxpayer income, filing status, and other relevant factors.

The pre-stored automatic tax filing condition may also include a compliance check with all applicable tax laws and regulations, including federal, state, and local tax laws.

In order to perform the pre-stored automatic tax filing condition checks, the systems server is configured to unpackage the taxpayer information package.

In event the taxpayer information package or the tax payment instruction does not comply with the pre-stored automatic tax filing condition, the systems server may raise an anomaly. The anomaly may include the details on the pre-stored automatic tax filing condition not met.

The systems server (140) may be configured to automatically transform the tax payment instruction and the taxpayer information package to comply with the pre-stored automatic tax filing condition not met earlier. The transformation may be performed based on pre-set rules of tax return correction established for each pre-stored automatic tax filing condition. The rules may include extracting and verifying the taxpayer information to confirm the details related to the anomaly. In the event the transformation is not performed or the anomaly is not rectified, an alert may be raised in the tax information and payment application requiring the manual correction of the anomaly.

At 414, transmitting the tax payment instruction to the pre-authorized tax payment digital server is performed.

According to an embodiment, when the tax payment instruction and the taxpayer information package is validated and found complaint to the pre-stored automatic tax filing condition, the taxpayer information package is transmitted directly to the governmental tax authority (160) and tax authority bank (170) for processing.

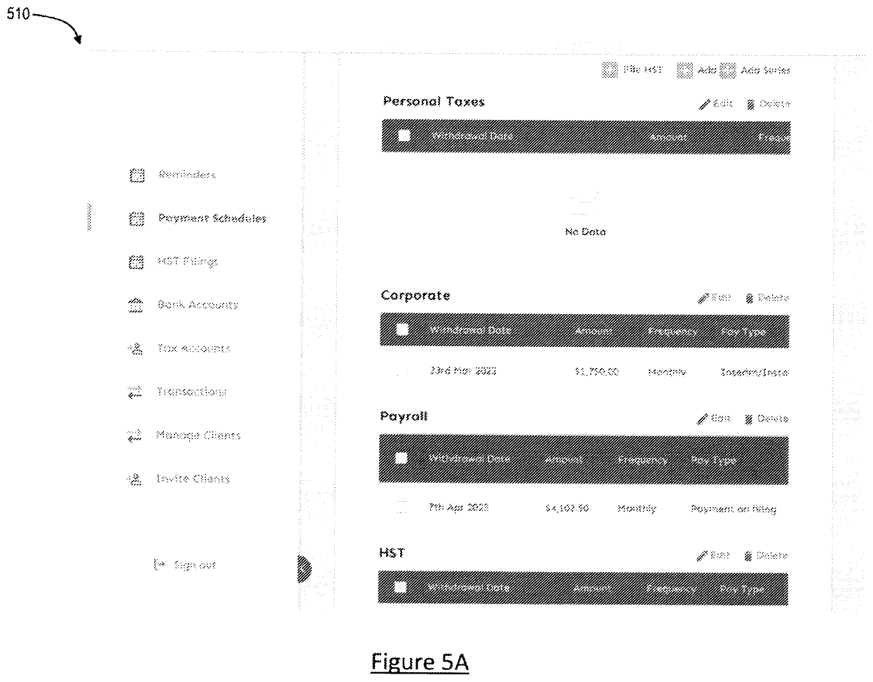

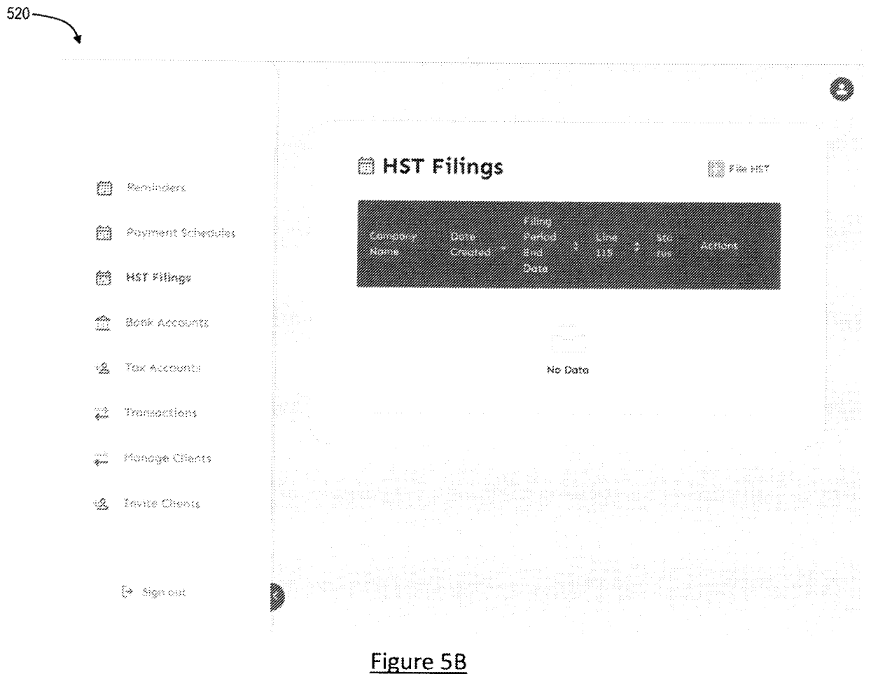

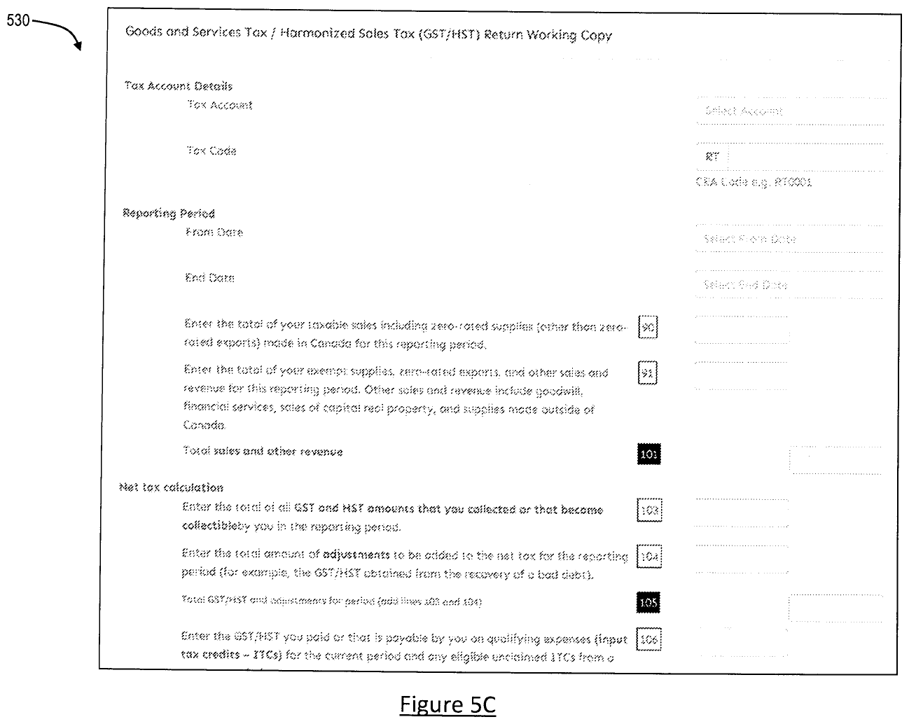

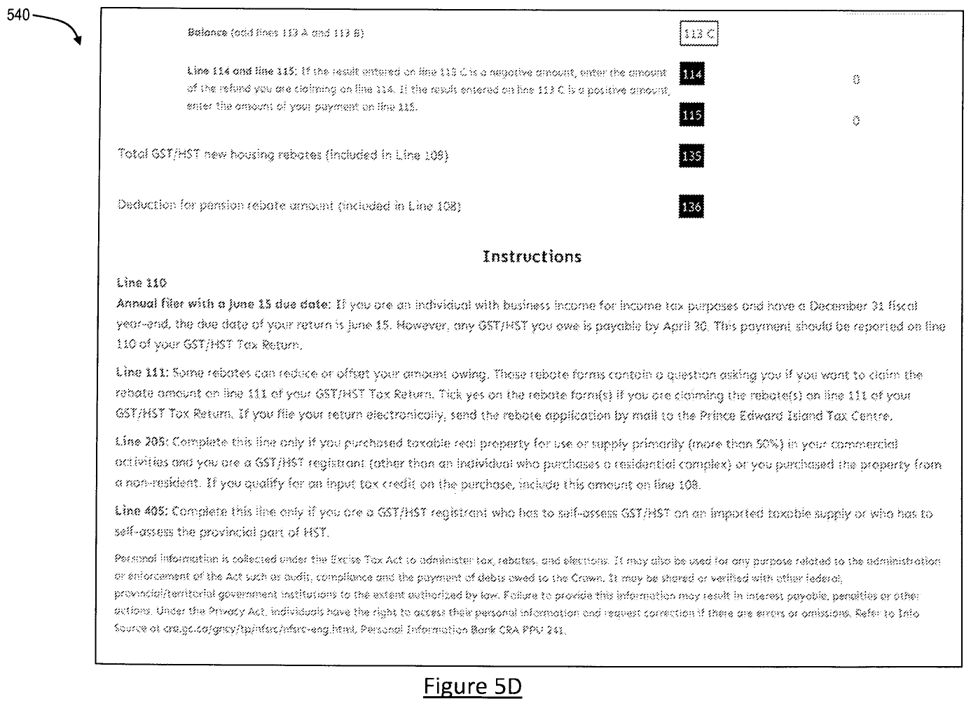

FIG. 5A shows a screen capture of the payment schedules in the tax information and payment platform, in accordance with an embodiment.

Screen capture 510 of the tax information and payment platform presents payment schedules of the tax processing service offered by the platform, including personal taxes, corporate, payroll, and HST.

The information on the payment schedule for corporate taxes includes withdrawal date, amount, frequency, and pay type. Further, the payment schedule information may include deadlines for filing returns, remitting tax payments, and any installment requirements for corporations with varying fiscal year-ends.

The section for payroll taxes includes the frequency of remittances based on the employer's size and payroll amounts, as well as any relevant deadlines and penalties. The section includes withdrawal date, amount, frequency, and pay type.

The Harmonized Sales Tax (HST) section includes withdrawal date, amount, frequency, and pay type. Further, the section may include HST payment schedule, including filing deadlines for returns, remittance due dates, and any relevant penalties or interest charges for late payments.

FIG. 5B shows a screen capture of HST filing in the tax information and payment platform, in accordance with an embodiment.

Screen capture 520 of the tax information and payment platform presents HST filing service offered by the platform. The platform is configured to indicate the Company Name, Date Created, Filing Period End Date, Line 115, Status, and Actions. The tax information package may be created by integrating the HST information listed on the platform.

The filing period end date may include the end of the reporting period for which the HST return is being filed. In Canada, the HST return is typically filed on a monthly, quarterly, or annual basis, depending on the size of the business and its revenue.

The status of the HST may indicate whether the return has been filed or not. The HST filing service will keep track of the status of each return and provide updates to the business owner. This information is crucial for ensuring that the business remains compliant with tax laws and avoids penalties and interest charges.

The Actions may include any additional steps that the client terminal may need to perform to complete the HST filing process. The steps may include reviewing and approving the return, making any necessary corrections or adjustments, and making payments to the Canada Revenue Agency (CRA).

FIGS. 5C and 5D show a screen capture of an GST/HST Working Form in the tax information and payment platform, in accordance with an embodiment.

Screen captures 530 and 540 of the tax information and payment platform presents a Goods and Service Tax/Harmonized Sales Tax Working Form to ensure accurate reporting.

The Working Form is configured to receive the Company Name and Reporting Period. The Reporting Period may be monthly, quarterly, or annually.

The Working Form may also receive Tax Account details. This includes the business records, Input Tax Credits (ITCs), total amount of taxable sales including zero-rated supplies, total amount of exempt supplies, zero-rated exports, and other sales and revenue including goodwill, financial services, sales of capital real property, and foreign supplies.

The Net Tax Calculation section included total amount of GST and HST collected or that became collectible during the reporting period; total amount of adjustments added to the net tax for reporting period; GST/HST paid on qualifying expenses; total GST/HST new housing rebates; and deductions for pension rebate amount.

While the above description provides examples of one or more apparatus, methods, or systems, it will be appreciated that other apparatus, methods, or systems may be within the scope of the claims as interpreted by one of skill in the art.

1. A system for directly processing tax information and payment, comprising:
at least one processor;
a memory, connected with the at least one processor;
a taxpayer device including a taxpayer profile;
a systems server configured to:
link the taxpayer profile to a pre-authorized tax payment digital server;
extract taxpayer information from the taxpayer profile in the pre-authorized tax payment digital server, wherein the taxpayer information includes a taxpayer bank account number and taxpayer accounting information;
generate a tax payment instruction from a taxpayer device associated with the taxpayer profile;
generate a taxpayer information package from the tax payment instruction and the taxpayer information, wherein the taxpayer information package is a computer file that includes information for processing a tax return;
transmit the tax payment instruction to the pre-authorized tax payment digital server;
validate the tax payment instruction on the pre-authorized tax payment digital server to verify compliance of the tax payment instruction to a pre-stored automatic tax filing condition;
transmit the tax payment instruction on compliance to a tax authority server; and
a tax authority server for receiving the tax payment instructions.

2. The system of claim 1, wherein the systems server is further configured to unpackage the taxpayer information package to generate the taxpayer information.

3. The system of claim 1, wherein the systems server is further configured to:
raise an anomaly when the tax payment instruction does not comply with the pre-stored automatic tax filing condition; and
automatically transform the tax payment instruction to comply with the pre-stored automatic tax filing condition.

4. The system of claim 1, wherein the pre-stored automatic tax filing condition includes a digital file format, a business number format, a reporting number format, a filing date, a reporting period, a tax rate, a data parameter, a net income, a tax payment certification.

5. The system of claim 1, wherein the pre-stored automatic tax filing condition includes either one or more of the file date to be within the reporting period and the tax rate to comply with a net income.

6. The system of claim 1, wherein the systems server is further configured to encrypt the tax payment instruction based on a pre-set encryption protocol.

7. The system of claim 1, wherein the system further comprises a bank server configured to transfer a tax amount to a tax authority account associated with the tax authority server.

8. The system of claim 1, wherein the taxpayer accounting information includes a net income, a sales tax number, a taxpayer name, a taxpayer address, and a taxpayer income document so that key detail are extracted to process the payment.

9. A method for directly processing tax information and payment, comprising:
linking a taxpayer profile to a pre-authorized tax payment digital server;
extracting taxpayer information from the taxpayer profile in the pre-authorized tax payment digital server, wherein the taxpayer information includes a taxpayer bank account number and taxpayer accounting information;
generating a tax payment instruction from a taxpayer device associated with the taxpayer profile;
generating a taxpayer information package from the tax payment instruction and the taxpayer information, wherein the taxpayer information package is a computer file that includes information for processing a tax return;
transmitting the tax payment instruction to the pre-authorized tax payment digital server;
validating the tax payment instruction on the pre-authorized tax payment digital server to verify compliance of the tax payment instruction to a pre-stored automatic tax filing condition; and
transmitting the tax payment instruction on compliance to a tax authority server.

10. The method of claim 8, wherein the method further comprises unpackaging the taxpayer information package to generate the taxpayer information.

11. The method of claim 8, wherein the method further comprises:
raising an anomaly when the tax payment instruction does not comply with the pre-stored automatic tax filing condition; and
automatically transforming the tax payment instruction to comply with the pre-stored automatic tax filing condition.

12. The method of claim 9, wherein the pre-stored automatic tax filing condition includes a digital file format, a business number format, a reporting number format, a filing date, a reporting period, a tax rate, a data parameter, a net income, a tax payment certification.

13. The method of claim 9, wherein the pre-stored automatic tax filing condition includes either one or more of the file date to be within the reporting period and the tax rate to comply with a net income.

14. The method of claim 9, wherein the method further comprises encrypting the tax payment instruction based on a pre-set encryption protocol.

15. The method of claim 9, wherein the method further comprises transferring a tax amount to a tax authority account associated with the tax authority server.

16. The method of claim 9, wherein the taxpayer accounting information includes a net income, a sales tax number, a taxpayer name, a taxpayer address, and a taxpayer income document so that key detail are extracted to process the payment.

17. A device for directly processing tax information and payment, comprising:
a collection module configured to linking the taxpayer profile to a pre-authorized tax payment digital server;
a processing module configured to:
extract taxpayer information from the taxpayer profile in the pre-authorized tax payment digital server, wherein the taxpayer information includes a taxpayer bank account number and taxpayer accounting information; and
validate the tax payment instruction on the pre-authorized tax payment digital server to verify compliance of the tax payment instruction to a pre-stored automatic tax filing condition;
a file generation module configured to:
generate a tax payment instruction from a taxpayer device associated with the taxpayer profile; and
generate a taxpayer information package from the tax payment instruction and the taxpayer information, wherein the taxpayer information package is a computer file that includes information for processing a tax return; and
a file transmission module configured to:
transmit the tax payment instruction to the pre-authorized tax payment digital server; and
transmit the tax payment instruction on compliance to a tax authority server.

18. The device of claim 17, wherein the processing module is further configured to unpackage the taxpayer information package to generate the taxpayer information.

19. The device of claim 17, wherein the processing module is further configured to:
raise an anomaly when the tax payment instruction does not comply with the pre-stored automatic tax filing condition; and
automatically transform the tax payment instruction to comply with the pre-stored automatic tax filing condition.

20. The device of claim 17, wherein the pre-stored automatic tax filing condition includes a digital file format, a business number format, a reporting number format, a filing date, a reporting period, a tax rate, a data parameter, a net income, a tax payment certification.
